(19) United States
(12) Patent Application Publication
(10) Pub. No.: US 2007/0276913 A1
(43) Pub. Date: Nov. 29, 2007

(54) Providing Access to Missed Text Messages in a Real-Time Text-Messaging Conference

(75) Inventors: Sean C. Olson, Duvall, WA (US); Ajay P. Chitturi, Bellevue, WA (US); Rajesh Ramanathan, Redmond, WA (US); Parag Samdadiya, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/419,945

(22) Filed: May 23, 2006

(51) Int. Cl. G06F 15/16

(52) U.S. Cl. 709/206; 709/217

(57) ABSTRACT

This document describes tools capable of enabling participants in a real-time, text-messaging conference to access text messages that they have missed, whether that be because they joined the conference late, were disconnected, or did not receive a message due to some sort of failure. Assume, for example, that a conference participant on a wireless laptop does not receive a text message because of a wireless connection failure. The tools, in one embodiment, enable the participant's laptop to notice that the text message was not received, ask for the missing text message, and receive the missing text message. The participant's laptop may then display the missing text message thereby allowing the participant to catch up with the conference and so not lose the context of the ongoing text-messaging conversation.

### BACKGROUND

Currently, participants in a real-time, text-messaging conference may not be able to see all of the text messages exchanged in that conference. If a participant joins the conference late, for instance, he or she may not see the text messages previously exchanged by other participants of the conference. Or if a participant is disconnected and later rejoins, he or she may not be able to see text messages exchanged by other participants while he or she was disconnected. And if a participant just does not receive a text message, such as when a communication network drops packets for that text message, he or she may not be able to see the missing text message or even know that it is missing.

### SUMMARY

This document describes tools capable of enabling participants in a real-time, text-messaging conference to access text messages that they have missed, whether that be because they joined the conference late, were disconnected, or did not receive a message due to some sort of failure.

Assume, for example, that a conference participant on a wireless laptop does not receive a text message because of a wireless connection failure. The tools, in one embodiment, enable the participant's laptop to notice that the text message was not received, ask for the missing text message, and receive the missing text message. The participant's laptop may then display the missing text message thereby allowing the participant to catch up with the conference and so not lose the context of the ongoing text-messaging conversation.

This Summary is provided to introduce a selection of concepts in a simplified form that are her described below in the Detailed Description. This Summary is not intended to identify key or essential features of the claimed subject matter, nor is it intended to be used as an aid in determining the scope of the claimed subject matter. The term “tools,” for instance, may refer to system(s), method(s), computer-readable instructions, and/or technique(s) as permitted by the context above and throughout the document.

### BRIEF DESCRIPTION OF THE DRAWINGS

FIG. 1 illustrates an exemplary operating environment in which various embodiments of the tools may operate.

FIG. 2 illustrates an exemplary central communication topology.

FIG. 3 illustrates an exemplary distributed communication topology.

FIG. 4 is an exemplary a time-flow graph illustrating devices of FIG. 1 that describes one way in which the tools may act to enable participants in a real-time, centralized text-messaging conference to access text messages.

FIG. 5 is an exemplary process illustrating various embodiments and manners in which the tools may enable access to text messages in a text-messaging conference as part of a centralized or distributed communication system.

The same numbers are used throughout the disclosure and figures to reference like components and features.

### DETAILED DESCRIPTION

### Overview

The following document describes tools capable of enabling participants in a real-time, text-messaging conference to access text messages that they have missed, whether that be because they joined the conference late, were disconnected, or did not receive a message due to some sort of failure. These tools may do so in distributed, centralized, or combined communication topologies.

An environment in which the tools may enable these and other actions is set forth below in a section entitled Exemplary Operating Environment. This section is followed by another section describing one exemplary way in which the tools may act to enable participants in a real-time, centralized text-messaging conference to access text messages that they have missed and is entitled Example Instant Messaging Conference in a Central Communication Topology. A final section describes various other embodiments and manners in which the tools may act to enable participants in a real-time, text-messaging conference to access text messages that they have missed in a centralized, distributed, or combined communication system and is entitled Other Embodiments of the Tools. This overview, including these section titles and summaries, is provided for the reader's convenience and is not intended to limit the scope of the claims or the entitled sections

### Exemplary Operating Environment

Before describing the tools in detail, the following discussion of an exemplary operating environment is provided to assist the reader in understanding some ways in which various inventive aspects of the tools may be employed. The environment described below constitutes but one example and is not intended to limit application of the tools to any one particular operating environment or conferencing system. Other environments and systems may be used without departing from the spirit and scope of the claimed subject matter.

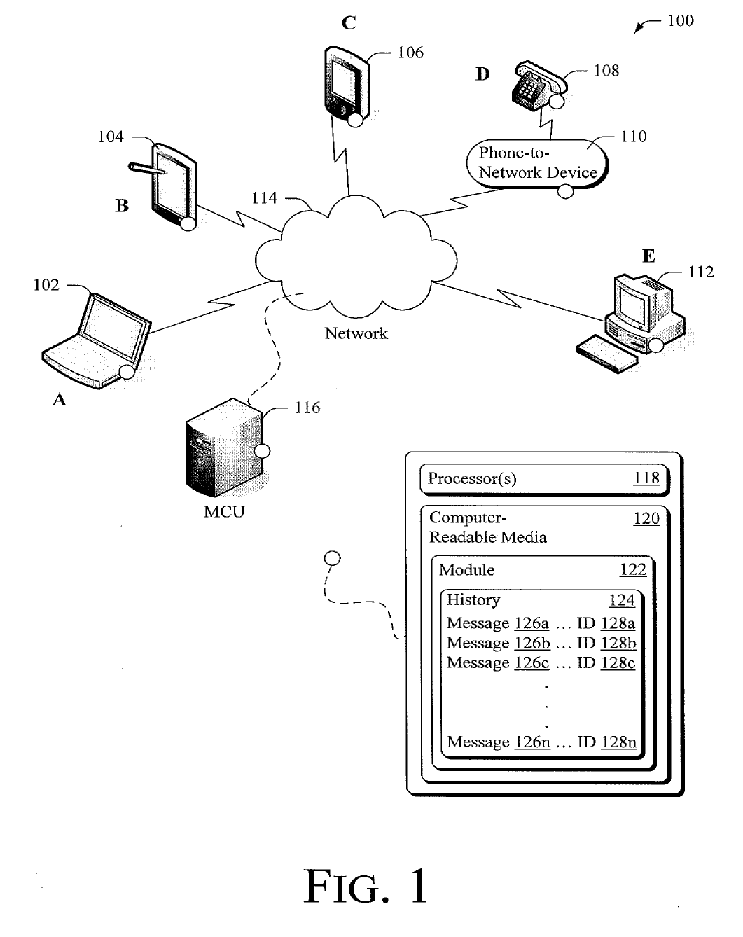

FIG. 1 illustrates one such operating environment generally at 100 having five conference participants, participant A shown communicating with a communication device 102, participant B shown communicating with a communication device 104, participant C shown communicating with a communication device 106, participant D shown communicating with a telephone 108 connected to a phone-to-network communication device 110, and participant E shown communicating with a communication device 112.

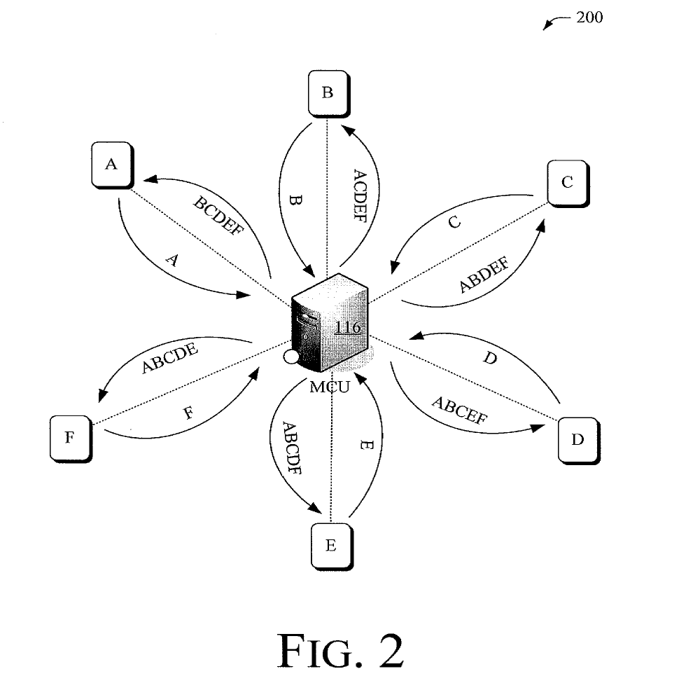

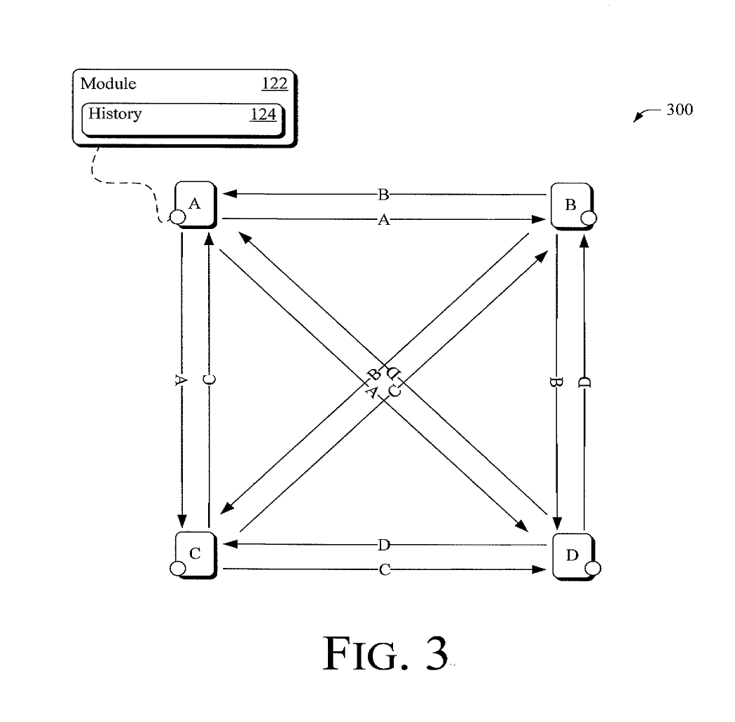

The environment also has a communications network 114, such as a company intranet or a global internet (e.g., the Internet) and in some cases has access to a server 116. The participants' devices may be capable of communicating directly to the network (e.g., a wireless-Internet enabled laptop, PDA, or a Tablet PC, a wired Internet-enabled desktop computing device, or VoIP-enabled telephone or cellular phone wired or wirelessly connected to the Internet) or indirectly (e.g., the telephone connected to the phone-to-network device). The conference may be enabled through a distributed (e.g., peer-to-peer) or central network topology (or a combination of these). Exemplary distributed and central network topologies are illustrated in FIGS. 2 and 3 and described below.

The server 116 and/or any of these devices, including the phone and the phone-to-network device, may be a computing device having one or more processor(s) 118 and computer-readable media 120 (each device and the server marked with “◯” to indicate this possibility). The computer-readable media comprises a text-messaging conference module 122 (“module”) and a text-message history 124 (“history”). Each of the text messages 126a through 126n in the history may have an associated unique identifier 128a through 128n, respectively. Each of the participants may also have an identifier usable to verify their identity (not shown). Note that the term “participants” is sometimes used interchangeably with the communication device used by the participants, as will be apparent by the context.

The processor(s) are capable of accessing and/or executing the computer-readable media. The module(s) are capable of sending and/or receiving text messages and other actions described in greater detail below. The module(s) and history(s) are shown as a cohesive unit, though each may be disparately placed.

Each of the participants may contribute and receive (through their devices) text messages in real time as part of a real-time, text-messaging conference. In a distributed conferencing system each of the participants includes a module and history, though the history may be incomplete. In the centralized conferencing system the module and the history are accessible by the server, though each of the participants may have a module and history as well. Example centralized and distributed conferencing systems are set forth below.

FIG. 2 illustrates an exemplary central communication topology 200. Here a text message is passed from each participant A through F to a text-messaging conference MCU (Multipoint Control Unit) on server 116. Participant A, for example, may send his or her text message to the server and receive back text messages from each of the other participants and through the server. This is shown with an “A” being sent to the server and the “BCDEF” being sent back. This MCU server passes text messages to participants and records the text messages received and sent in its history. Note that the server comprises or has access to the module and history (shown with the “◯”).

FIG. 3 illustrates an exemplary distributed communication topology 300. Here text messages are passed from each participant A through D to each other participant through the communication network, either directly or through Network Address Translators (NATs) or media relays or a combination thereof. Participants A through D may be instant messaging online, for instance. Participant B, for example, passes his or her text message to each participant A, C, and D (sending and receiving text messages is shown with arrows). In this distributed topology, there are multiple instances of the module executed by a computing device of each participant (e.g., a participant's laptop). This is shown with the “◯” marked at each of the participants/devices and with one example module and history for participant A.

In either of these topologies or a combined topology, the module receives text messages from conference participants and records at least the most-recently received message or a unique identifier for each message. In a central communication topology, the MCU server records all of the messages, to whom they are sent, from whom they are received, and unique identifiers for each message. Also in the central communication topology, each participant's communication device records at least the last message or a unique identifier for the last message. In a distributed communication topology, each of the participant's modules may record all of the text messages received. As will be discussed below, if any one of the participants recorded a text message missed by another of the participants, the text message may be accessed by the other participant that missed it. For ease in explanation, the following examples cover three participants, though many more may be handled.

### Example Instant Messaging Conference in a Central Communication Topology

In this section three wireless devices A, B, and C of FIG. 1 are used to describe one exemplary way in which the tools may act to enable participants in a real-time, centralized text-messaging conference to access text messages. This example is an implementation of the tools but is not intended to limit the scope of the tools or the claimed embodiments.

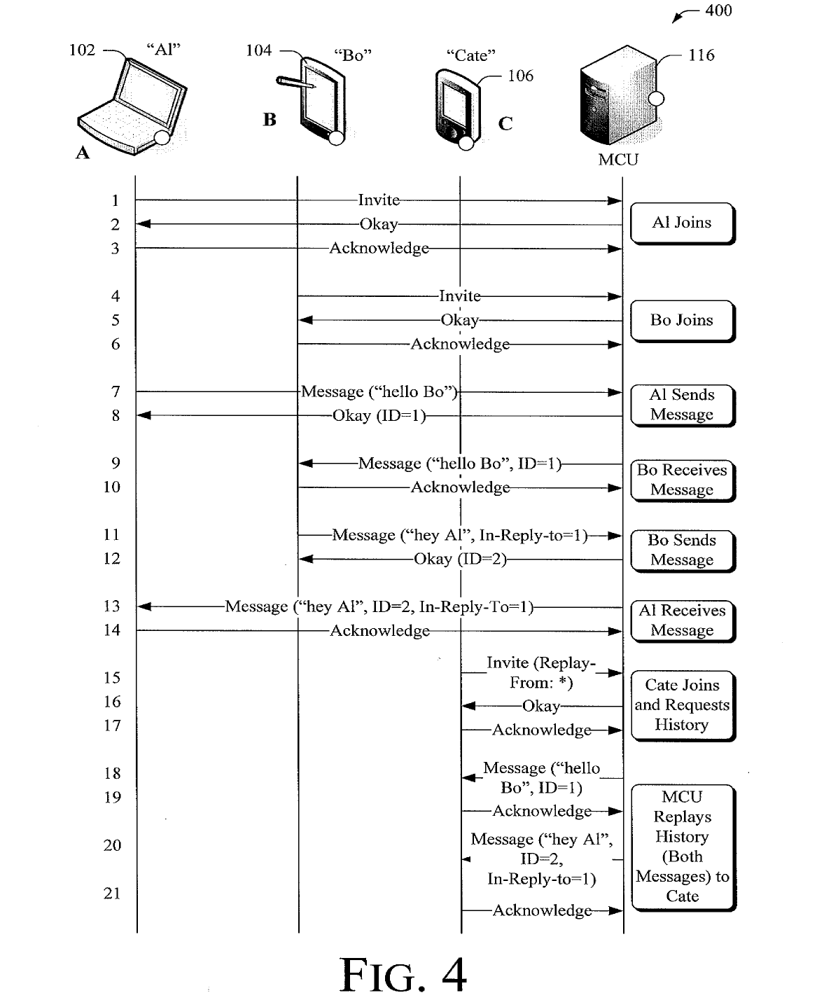

This example is illustrated in FIG. 4 with actions of three participants named “Al”, “Bo”, and “Cate”, their communication devices 102, 104, and 106, and MCU server 116 (which has module 122 and history 124) shown in a time-flow graph 400. Each communication is made using SIP (Session Initiation Protocol) or SIMPLE (Session Initiation Protocol for Instant Messaging and Presence Leveraging Extensions) and shown with an arrow between the participant and the server across a communication network (not shown). This graph 400 shows the server providing missing messages to a new participant.

At arrows 1, 2, and 3, Al joins an instant-messaging conference hosted by the MCU server. Here joining involves sending an invite, receiving an okay, and sending an acknowledgement in response to the okay.

At arrows 4, 5, and 6, Bo joins the same instant-messaging conference. Al then sends Bo a message, namely “hello Bo”, at arrows 7 and 8. To do so, Al sends the message to the MCU server, which responds that it received the message and also gives that message a unique identifier. Here the identifier is simply a “1”, though other types of identifiers could be used (e.g., a unique time-stamp).

The MCU server then sends that message to the other participants, here just Bo at arrows 9 and 10. Bo receives this message and then responds to Al at arrows 11 and 12. Bo responds with a message, namely “hey Al”, which Bo's device sends to the MCU server and in response to which the MCU server responds that it received the message and gives it a unique identifier (here “2”).

The MCU server then sends that message to Al at arrows 13 and 14. The history built up by the MCU server so far is:
Message “hello Bo”: Unique ID=1
Message “hey Al”: Unique ID=2, In-Reply-to =1

This history indicates the text of the messages, their unique identifiers, and their chronology, here through the unique identifier gaining at a set value (e.g., from 1 to 2, from 2 to 3, and so forth) and also by recording that each message after the first is in reply to the immediate-prior message. Note also that each of the device's 102 and 104 may also record the messages, their unique identifiers, and/or their relationship. This information may be stored by each device's module or other software and in a history, such as module 122 and history 124 of FIG. 1.

At arrows 15, 16, and 17 Cate joins the same instant-messaging conference and requests the conference's history. The MCU server may require that a participant request history or may just send it to them when they join or rejoin. The MCU server may also require that one or more of the other participants (those participants that sent and received the desired history) assent to another (e.g., new) participant getting the history. Here, however, the MCU server requires only that the history be requested.

At arrows 18 and 20 the MCU server sends the history to Cate. Here the MCU server sends all of the history of the conference, namely the first and second messages and in the order they were first received by the MCU server. The MCU server may send them as a block or message-by-message. At arrows 19 and 21 Cate's device acknowledges receiving each of the messages.

Cate's device also displays these text messages to Cate so that she can get up to speed with the conference. Thus, she can see in her conference user interface first “hello Bo” and then “hey Al”. With these messages she can know that very little has happened (just Al and Bo saying hello to each other).

As is apparent, this is a relatively simple case. There are only three participants and the participant needing the history is a new participant that missed little of the conference. In many cases, however, a new participant will have missed many messages and need these messages to be able to contribute to the conference. In other cases, one of the participants may become disconnected or not receive a message due to some sort of failure. In these cases the MCU server (namely the module and history on the MCU server) may act to provide these missing text messages.

Consider, for example, a case where Al is disconnected or simply does not receive messages for a period of time. Assume that Cate, in this space of time, sends a message: “hello Al, can you send me that Power Point document?”. This message is received by the MCU server, which assigns it a unique identifier “3”, notes that it is in reply to message 2 (“hey Al”), and then sends this message to both Al and Bo. But here Al does not receive it. Here both Al's device and Bo's device record the unique identifier of the last message they received in their local histories. Thus, Al has unique identifier 2 in its history. Bo received the message from Cate and so has unique identifier 3 in its history and also that this message was in reply to message 2. Now assume that Al rejoins or his device is otherwise now receiving messages properly. Bo sends a reply to Cate with a message “Cate, I updated Al's Power Point, I'll send it to you via email”, which the MCU server records, assigns a unique ID of 4, and that it is in reply to message 3. The history at the MCU server is now:
Message “hello Bo”: Unique ID=1
Message “hey Al”: Unique ID=2, In-Reply-to =1
Message “hello Al, can you send me that Power Point document?”: Unique ID=3, In-Reply-to =2
Message “Cate, I updated Al's Power Point, I'll send it to you via email”: Unique ID=4, In-Reply-to =3

The MCU server then sends Bo's message to both Al and Cate, which Al receives. Note here that Al's history will show a problem:
Message “hello Bo”: Unique ID=1
Message “hey Al”: Unique ID=2, In-Reply-to =1
Message “Cate, I updated Al's Power Point, I'll send it to you via email”: Unique ID=4, In-Reply-to =3

Al's module determines that a message is missing. Here it may determine this because it has a unique ID=2 and a unique ID=4 but no unique ID=3. By so doing, the module determines that it did not receive the message with unique ID=3. Or it may determine this because it received a message in-reply-to message 3 but it does not have message 3. In either case Al's module knows that it is missing a message.

In response, Al's device automatically requests message 3 from the MCU server. The MCU server previously retained this message and its unique identifier and so can find it and send it to Al's device. Al's device may then display it to Al and as part of the ongoing conference. Al is now up to speed on the conference and so knows that Cate asked him for the Power Point document but that Bo stepped up and sent a newer version instead.

### Other Embodiments of the Tools

In the above section exemplary ways are described in which the tools may act to enable participants in a real-time, centralized text-messaging conference to access text messages. Below other embodiments of the tools are provided that may be implemented in a centralized, distributed, or combined communication system and for a conference where two or more participants exchange text messages.

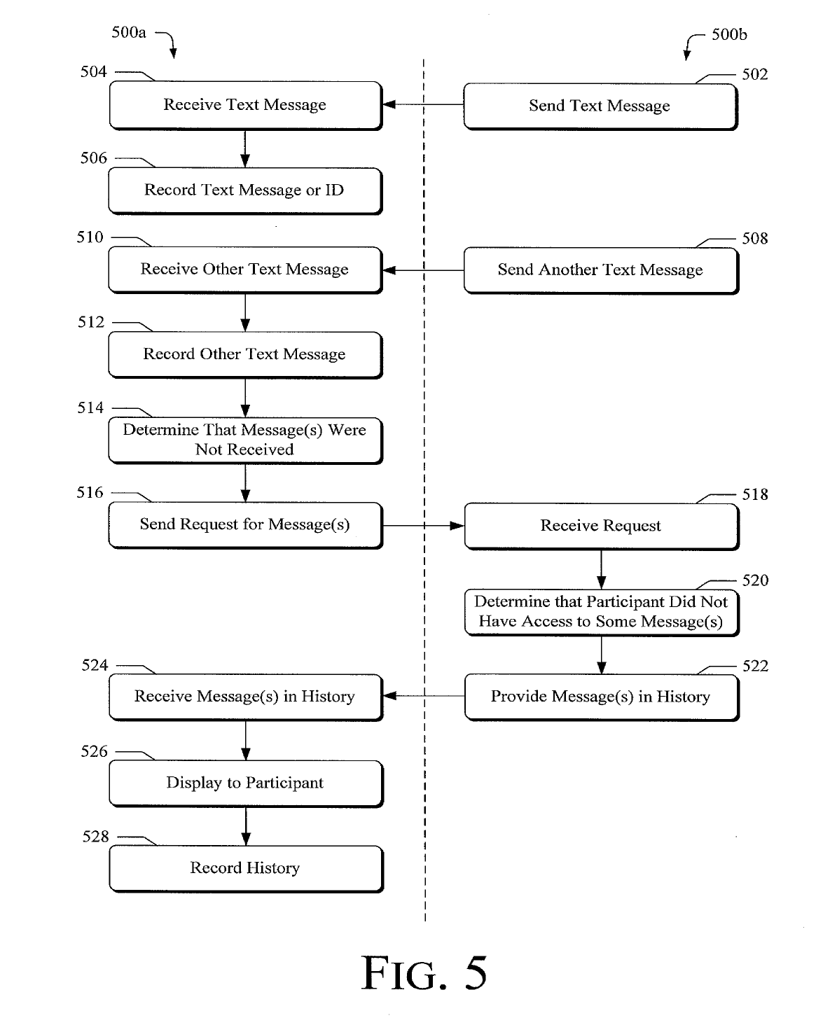

These exemplary embodiments are described as part of two processes 500a and 500b of FIG. 5. These processes of FIG. 5 and the exemplary actions related to FIG. 4 may be implemented in any suitable hardware, software, firmware, or combination thereof; in the case of software and firmware, these processes represent sets of operations implemented as computer-executable instructions stored in computer-readable media and executable by one or more processors. These embodiments of the tools are not intended to limit the scope of the tools or the claims.

These processes 500a and 500b are separated by a dashed line through which the entities communicate over a communication network, such as network 114 of FIG. 1. Process 500a shows actions of a participant through his or her communication device (e.g., its module 122). Process 500b shows actions of either a distributed communication topology entity (e.g., another participant through one of communication devices 102, 104, 106, 110, or 112 of FIG. 1) or a centralized communication topology entity (e.g., the MCU server 116 of FIG. 1). The entity of process 500b has access to a history of text messages of the conference (e.g., history 124 of FIG. 1). Process 500b may be implemented, for example, with module 114 on device 106 with access to a local example of history 124 of the text messages 128 or by module 114 on server 116 with access to its own central history 124 of text messages 128. The communication device of process 500a and the entity of process 500b are remote from each other.

Block 502 sends a text message, which is received at block 504. This text message may include or be sent with an indicator useful in determining that some other message has not been received. This message may be from another participant of the conference's device and sent directly or through an intermediary. If the message is from another participant in a central communication topology, for instance, the message may have been sent to an MCU server before being sent by the server at block 502. If the message if from another participant in a distributed communication topology, it may have been sent directly from the other participant. In any of these cases, the sender or senders may store all of the messages of a conference. In some embodiments they do so in an archives in which case all of the messages may be retrieved even if the number of messages or the storage requirement for the messages are quite large.

Block 506 records this message and/or an included indicator. In the example described above, module 122 records an indicator comprising a unique identifier for that message in a local history 124. This message or identifier may be used to determine if other messages may be missing.

Block 506 may record many or all of the messages and/or indicators that it receives (though this may not be all of the messages or indicators of the conference). This may aid in later displaying messages that were missed in their correct sequence relative to messages that were not missed.

Block 508 sends another message, which is received at block 510. This message may also include or be sent with an indicator that is useful in determining that some other message has not been received.

Block 512 records this message and/or its indicator as previously done at block 506. Block 512 may choose to record just the indicator (e.g., a unique identifier), though in a distributed communication topology the module may record the messages too so as to be able to provide them to another participant at some later time.

Block 514 determines that one or more messages have not been received. Block 514 may do so by comparing indicators of two messages that have been received, such as the message received at block 506 and the message received at block 512. Block 514 may also do so with an indicator indicating a relationship between the second received message and another message that has not been received. In the above example Al's device determines that it did not receive the message from Cate because Bo's message included an indicator indicating that Bo's message was the fourth message and Al's device knew that it had only last received a second message.

Block 516 sends a request for text messages, such as with an indicator indicating that one or more text messages were not received. In some cases this request indicates that all of the history retained by the entity to which it is sent is desired. In this case the request may be from a new participant (which will not have performed prior blocks). This new participant likely desires all of the text messages of the conference. In some other cases the participant that sends the request is not new but desires all of the history. The participant may want all of the history for some other reason, such as to record and forward it in an email. Or the participant's device may think it is missing a message and so intend to compare all of the messages in the conference with its own retained history, determine which have not been shown to the participant, and show those messages to the participant.

In still other cases, the request includes an indicator having a unique identifier of a message last-received in real-time or last-received prior to the message used to determine that a message is missing. If the participant's device knows that there is a problem the device may send this request and indicator, though the device may determine that there is a problem by knowing that a message is or may be missing. A message may be missing if a participant is dropped from the conference and he or she rejoins, though in some cases he or she may rejoin fast enough to not miss a message.

This indicator may also comprise information indicating that the participant was or is a part of the conference. An identifier for the participant, for instance, may be sent with the request so that the entity may determine if the participant should be allowed to see the requested text messages.

The request at block 516 may also indicate at what rate or in which manner to provide the messages, such as one message every five seconds, the messages twice as fast as they were originally made, or all of the messages sent in bulk.

Block 518 receives the request for text messages, which may include an indicator. Block 520 determines that the participant has not had access to at least some of the history. The tools may determine that the participant has not had access to any of the history based on the indicator indicating that the participant just joined the conference for the first time. Or the tools may determine that the participant has had access to some of the history based on the indicator indicating that the participant has rejoined the conference. In this case the indicator may include a verifiable identity for the participant. It may also indicate a time at which the participant was dropped from the conference.

In some cases, the tools determine which messages the device is missing with a unique identifier for the messages or a relationship between them, such as message with ID=3 in the above example. This determination may be trivial when the participant's device indicates with specificity which messages are desired (e.g., by sending each desired message's unique identifier). In some cases, however, the tools compare the unique identifiers of messages that have been received by the participant with unique identifiers for all of the conference's recorded messages and send those that were not received.

Block 522 provides some or all of the history. The tools may provide only those messages indicated by the participant as having been missed (e.g., those subsequent to the last one received in the proper order). Or the tools may provide all of the history and let the participant's device determine which were missed and which were not. To aid the participant's device, the tools may provide information about the messages sufficient to determine which of the messages the participant has not previously had access. In one case the tools do so with unique identifiers for each message provided. With these unique identifiers the participant may sort through and find those that were missed.

The tools may provide the history at various rates or in various manners, such as messages per some unit of time, a speed relative to how fast they were originally received (e.g., faster, the same, or slower), in bulk, and so forth. If a rate or manner was requested at block 516, the tools may provide the messages as requested. This may make handling and display by the participant's device at block 526 easier, such as by the participant's module 122 being able to handle the messages similarly to those sent in the normal course of the conference.

As noted in the above example related to FIG. 4, the tools may provide to another participant an option to permit access of the history to the requesting participant. In this case block 522 may refrain from sending any or certain portions of the history based on a lack of permission from one or more other participants.

Block 524 receives the history. In some cases the device receives the history and displays (at block 526) whatever messages were not previously viewed by the participant. As noted in the above example of FIG. 4, the device may provide these in the user interface for the ongoing conference and in the order they were received. Thus, the device may show the message “hello Al, can you send me that Power Point document?” right after “hey Al” and right before “Cate, I updated Al's Power Point, I'll send it to you via email”.

Block 528 optionally records the history, whether all of it was received at block 524 or in the normal real-time course of the conference.

### CONCLUSION

The above-described tools enable participants to gain access to text messages in a text-messaging conference. The tools may do so in various types of communication topologies and permit participants to stay up to speed with a conference whether they are new, disconnected, or do not receive messages due to a failure. Although the tools have been described in language specific to structural features and/or methodological acts, it is to be understood that the tools defined in the appended claims are not necessarily limited to the specific features or acts described. Rather, the specific features and acts are disclosed as exemplary forms of implementing the tools.

1. One or more computer-readable media having computer-readable instructions therein that, when executed by a computing device, cause the computing device to perform acts comprising:
determining that a remote participant of a conference in which textual messages are exchanged in real-time does not have access to at least some of a history of textual messages exchanged in the conference; and
providing said some or all of the history to the remote participant while the remote participant is in the conference.

2. The media of claim 1, wherein the act of determining determines that the remote participant has not had access to any of the history and the act of providing provides all of the history.

3. The media of claim 1, wherein the act of determining determines that the remote participant has not had access to said some of the history and the act of providing provides said some of the history.

4. The media of claim 1, wherein the act of providing provides all of the history and further comprising providing information about the textual messages of the history sufficient to enable determination of which of the textual messages of the history to which the remote participant has not previously had access.

5. The media of claim 4, wherein the information comprises unique identifiers for each of the textual messages capable of comparison with a particular unique identifier for a particular textual message last accessible by the remote participant effective to provide subsequent textual messages of the history to which the remote participant has not previously had access.

6. The media of claim 1, further comprising receiving a request indicating a rate or a manner in which to provide the messages of said some or all of the history and wherein the act of providing provides the messages of said some or all of the history at the indicated rate or in the indicated manner.

7. The media of claim 1, wherein the act of determining receives an indicator indicating that the remote participant does not have access to at least some of the history.

8. The media of claim 7, wherein the act of determining determines, based on the indicator, that the remote participant just joined the conference for the first time.

9. The media of claim 7, wherein the act of determining determines, based on the indicator, which of the textual messages of the history to which the participant has not had access.

10. The media of claim 9, wherein the indicator indicates that the remote participant had previously been a participant of the conference and a textual message or time at which the remote participant had last been a participant of the conference.

11. The media of claim 7, wherein the indicator indicates a verifiable identity of the remote participant and further comprising providing said some of the history only if the remote participant is verified to have previously been part of the conference.

12. The media of claim 7, wherein the indicator indicates the remote participant's identity and further comprising providing to another participant of the conference an option to permit the remote participant to have access to said some of the history, and wherein the act of providing provides said some of the history only responsive to receiving permission from said other participant to provide said some of the history to the remote participant.

13. The media of claim 7, wherein the indicator is received over a communication network and the remote participant is a wireless computing device.

14. A method implemented at least in part by a computing device comprising:
sending to a remote recipient a unique identifier indicating a textual message last received in real-time by a participant of a conference in which textual messages are exchanged in real-time; and
receiving from the remote recipient textual messages that were not previously received by the participant and that are subsequent to said textual message last received by the participant.

15. The method of claim 14, wherein the remote recipient is a multi-point control unit and said textual messages were supplied to the conference by other participants.

16. The method of claim 14, wherein the remote recipient is another participant of the conference and wherein the conference is a peer-to-peer instant messaging conference.

17. The method of claim 14, further comprising sending to the remote recipient an identifier for the participant sufficient to enable the remote recipient to determine that the participant was previously part of the conference.

18. The method of claim 14, further comprising displaying said textual messages in an instant-messaging user interface through which the textual message last received was previously displayed and during the conference.

19. The method of claim 14, further comprising receiving, from the remote recipient and prior to the act of sending, another textual message and its other unique identifier and determining, based on the other unique identifier and the first-mentioned unique identifier, that one or more textual messages were received by the conference but not received by the participant and wherein the first-mentioned act of sending is responsive to the second-mentioned act of receiving and the act of determining.

20. The method of claim 14, wherein the remote recipient is a communication device of another participant of the conference and the conference is a distributed text-messaging conference.
